(19) United States
(12) Patent Application Publication
(10) Pub. No.: US 2005/0177744 A1
(43) Pub. Date: Aug. 11, 2005

(54) Secure key reset

(76) Inventor: Barry Steven Herman, Atherton, CA (US)

Correspondence Address: EMC CORPORATION, 6801 KOLL CENTER PARKWAY, PLEASANTON, CA, 94566, US

(21) Appl. No.: 10/821,482

(22) Filed: Apr. 9, 2004

Related U.S. Application Data
(60) Provisional application No. 60/542,578, filed on Feb. 6, 2004.

(51) Int. Cl. H04L 9/00

(52) U.S. Cl. 713/200

(57) ABSTRACT

A method, article of manufacture, and apparatus for securely resetting a key. In an embodiment, this comprises setting a flag to indicate that the key is to be reset, starting a process associated with the program, determining, when the process has been started, whether the flag is set, and resetting the key to a default value based on the flag.

### CROSS REFERENCE TO RELATED APPLICATIONS

This application claims priority to co-pending U.S. patent application No. 60/542,578 (Attorney Docket No. L111USP) entitled SECURE METHOD OF INDEPENDENTLY RESETTING PASSWORD, filed Feb. 6, 2004, which is incorporated herein by reference for all purposes. This application is related to co-pending U.S. patent application Ser. No. ______ (Attorney Docket No. L116US), filed ______, which is incorporated herein by reference for all purposes.

### FIELD OF THE INVENTION

This invention relates generally to a method, article of manufacture, and apparatus for management of keys in a protected computer system. More particularly, this invention relates to providing a user with the ability to securely and independently reset a password, without requiring a party holding a backdoor key to intervene.

### BACKGROUND

This invention relates to management of keys in a protected system. Software applications may control access by requiring a user to enter a key (password), often in conjunction with a username. Information about user accounts and passwords may be stored in an embedded database. Typically, an administrator account with the ability to gain full access to all features and user accounts is created, and the login information for the administrator account is stored in the database. For security reasons, the usernames and passwords in the database may be encrypted.

When the software is delivered to the customer, the administrator account has a default password, which the customer changes. This administrator password is generally kept confidential, known only to one or a few persons.

From time to time, the administrator password may be lost. This can happen for a variety of reasons, such as employee turnover, loss of documents or files in which the password is kept, forgetfulness, etc. If the administrator password is lost, the usual recourse is to contact the manufacturer that produced the software to ask for the password to be reset. The manufacturer typically has methods for doing so that it does not wish to be revealed, so that it will not jeopardize the security of its products, which may be installed at other customer sites.

Because this process requires interaction with the manufacturer's technical support, this process often results in delays for the customer who needs to reset its password. This is particularly problematic when the software application is critical and downtime may be costly for the customer.

There is a need, therefore, for an improved method, article of manufacture, and apparatus for providing a user with the ability to securely and independently reset a key, without requiring a party holding a backdoor key to intervene. Using this approach, a customer may reset a forgotten administrator password without the delay and interaction traditionally required.

### SUMMARY OF THE INVENTION

Briefly, therefore, this invention provides for a method, article of manufacture, and apparatus for securely resetting a key. In an embodiment, this comprises setting a flag to indicate that the key is to be reset, starting a process associated with the program, determining, when the process has been started, whether the flag is set, and resetting the key to a default value based on the flag.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram of an application server using a database system and in communication with a console client and a backup server;

FIG. 2 is a diagram of an application server in communication with several backup servers in several data zones;

FIG. 3 is a flowchart illustrating the process of a secure password reset system;

FIG. 4 is a flowchart illustrating the process of using a secure password reset system; and

FIG. 5 is a flowchart illustrating the operation of a secure password reset system.

### DESCRIPTION OF THE INVENTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

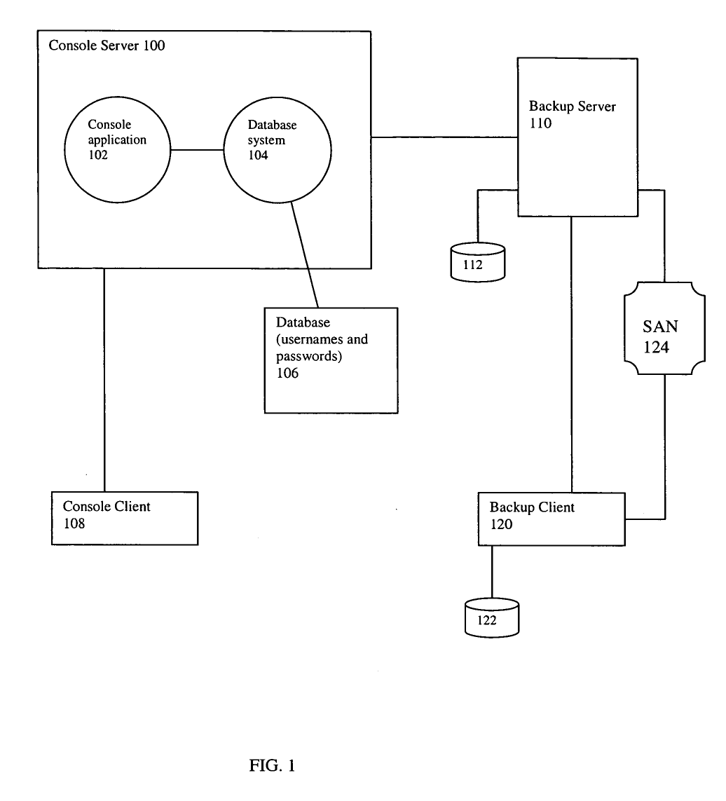

Software applications may have functionality or data to which it is desirable to restrict access. For example, a software application, such as the Legato NetWorker Management Console application, is installed on a server machine 100 as shown in FIG. 1. The NetWorker family of software products is available commercially from Legato Software, a division of EMC Corporation. The server machine 100 may be a general purpose computer running some flavor of Unix or Linux, or it may be running some other operating system such as Windows 2000.

The console application 102 communicates with a database system 104 to store keys (passwords) that are used to access the application 102. The database system 104 may be an embedded Structured Query Language (SQL) database such as SQL Anywhere, available commercially from iAnywhere, a Sybase company. The keys are stored in a database 106 in encrypted form using an encryption algorithm such as Secure Hash Algorithm, developed by the National Institute of Standards and Technology, and described in Federal Information Processing Standards Publication 180-1. The database 106 is stored in a non-volatile storage device such as a hard disk drive. The database system 104 itself may require a password to access the database 106, which the console application 102 supplies when required.

In this example, the console application 102 running on console server 100 communicates with server machine 110, which is running a NetWorker Server backup software application. The server machine 110 communicates with NetWorker Clients running on host machines 120 to perform backup functions, including backing up data stored by the host machines. The host machines may be running Unix, Windows, VMS, or any other operating system, and need not be running the same operating systems. Data from the host machine may be backed up to a storage device 122 associated with the client host machine 120, a storage device 112 associated with the server 110, or a Storage Area Network (SAN) 124. The data from the client host machine 120 may be sent through the server machine 110 to the selected storage device, or it may be sent directly from the client 120 to the selected storage device without burdening the server 110 that requested the transfer. The storage device 112 or 122 may comprise various mass storage devices that may be organized into filesystems, or be a specialized storage appliance, such as hard disk drives singly, in a RAID array, or other configuration. It may also comprise devices that are cheaper, slower, or intended for archival purposes, such as optical drives, tape drives, magneto-optical drives, or any combination of these.

The console application 102 running on console server 100 communicates with server machine 110 by use of an administrative interface. Through this interface, the console application 102 can perform many administrative tasks, such as adding a new client machine 120 to be backed up by the backup server machine 110, changing the time when such client is backed up, and defining what data is backed up from this client.

Once a client 120 is defined to the server 110 and its backup time is reached, the server 110 starts the backup process by contacting the backup service executing on the client 120. This client service responds to the server 110 with information about the type of machine and its file system configuration. The server 110 may use this response to start separate backups on the client for each file system. The server 110 may also start backups of more specialized data, such as databases or mail services.

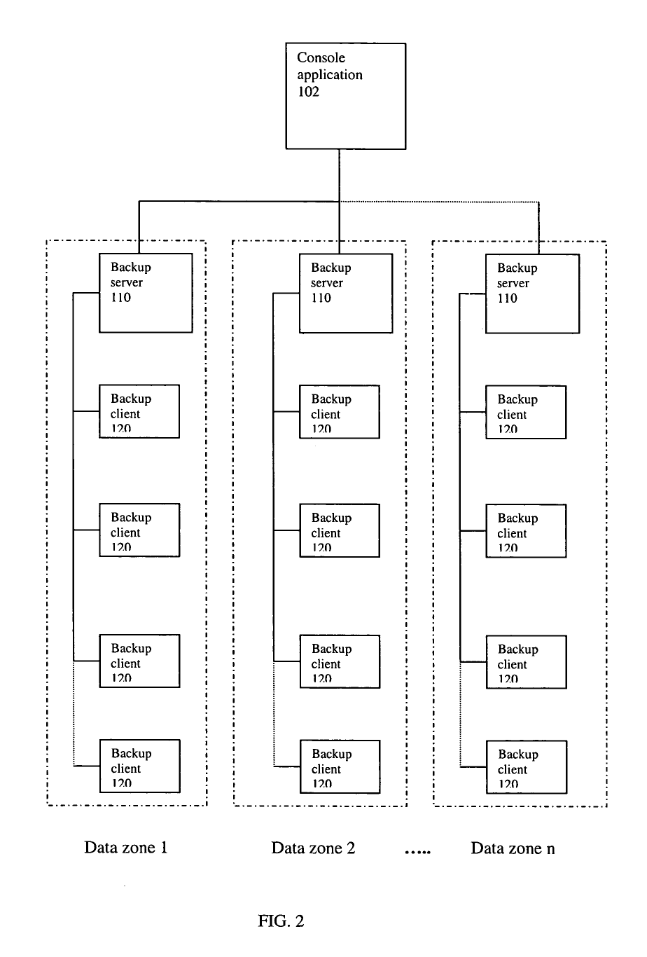

The console application 102 may be used to communicate with several servers 110, for administration purposes such as scheduling, configuration, reporting, and assignment of servers 110 to clients 120. For example, each server 110 with its clients 120 may represent a data zone that corresponds to a different department or group in an organization. The console 102 may thus be used to manage multiple data zones, as shown in FIG. 2.

Console 102 distinguishes between groups of users with different access levels assigned to each group. For example, one group may have administrator-level access, with full access to all features of the console and the ability to add or delete other users, as well as reset their passwords. Another group may have user-level access, with the ability to administer servers 110, create and view reports, but not the ability to add and delete other users or alter passwords. More groups may be defined, such as having operator-level access with less access than administrator but more than user, user groups that have access to some data zones but not to others, or user groups that have the ability to create and view reports, but not to alter server configurations or scheduling. Group-level privileges may also be administered by the server 110 through an access control list that identifies privileges allowed to each group.

A user may communicate with the console application 102 by logging in directly to the console machine 100, or remotely from a console client 108. In both cases, the user would be asked to provide a username and password to the console application 102. The login may be handled by a login service as part of a toolkit, such as Legato's Generic Services Toolkit (GST), an application framework that provides basic services that an application would use (login services, user management, client session management, licensing, etc.).

The console application 102 has a default administrator account, and a default password is given to the customer. For security reasons, the customer typically changes the default password after receiving and installing the software. As with other usernames and passwords, the administrator account name and password are stored in the encrypted database 106. The database system 104 requires a key (password) to access the database 106, such as for adding, deleting, or changing a username or password. The application 102 provides this key to the database system 104. The key to access the database is kept secret by the manufacturer of the application 102, to protect the security of copies of its product installed by other customers.

Due to employee turnover or data loss, the customer may lose its password for accessing the administrator account for the console application 102, and thus lose its ability to login to the application 102 as administrator. At this point, the customer cannot reset the administrator password, since the application 102 will not use the database key to cause a reset of the administrator password in the database 106 unless the user requesting the change is logged in as an administrator. The customer must send the encrypted database 106 back to the manufacturer, where technical support personnel will use a secret database key as a backdoor to access the database. This secret key may be for the account used by the application 102 to access the database, or it may be another backdoor account. Using an SQL command or other command to access the database, the administrator password may be reset to a default value. The manufacturer then returns the database to the customer, along with the reset administrator password.

This process requires several interactions between the customer and technical support personnel, as the request to reset the password must be made, the customer's identity must be verified, and the database must be transferred more than once. These add up to significant delays, which may cause problems where the application 102 is critical and delays result in costly downtime or reduced functioning. Even though the customer may retain a copy of its database, it will be unable to perform administrator-level functions until the database is returned with the reset administrator password.

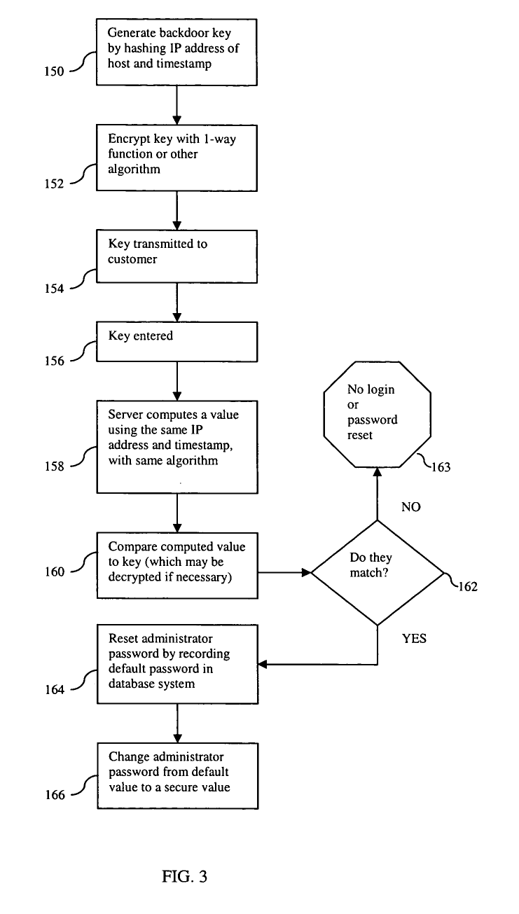

A solution is to create a backdoor key that changes periodically, and is computed on the manufacturer's computer (remote from the customer's computer) by an algorithm known only to the manufacturer, as illustrated in FIG. 3. The algorithm may be a function that takes into account the current date and time, as well as distinguishing features of the customer's configuration (such as CPU identification number or IP address), so that the key would be unique to that customer. This algorithm may be built into the application 102 to create the backdoor. If the customer requests a backdoor key from the manufacturer, the manufacturer generates this key, step 150, encrypts it, step 152, and sends it to the customer (after determining that the request for the key is legitimate), step 154. The encryption may be performed during the generation of the key. If the algorithm for the backdoor key takes time into account, the generated key will be usable only for a limited time. In step 156, the customer enters the key at login to the application 102. This key may be used as an administrator password by the application 102 (i.e. treat as a successful login by administrator), or as a special password that instructs the application 102 to reset the administrator password to its default value.

The algorithm for a time-based backdoor key may combine both the IP (Internet Protocol) address of the server that runs the application (e.g. console server 100) and a specific time of the current month, such as the last second of the month. Other ways of uniquely identifying the host may be used, singly or in combination, such as CPU identification number and hardware configuration and application license number. Similarly, other times may be chosen, such as the first second of the following week. Any arbitrary time may be chosen, but this time should be sufficiently far in the future to facilitate usage of the backdoor key before it expires.

By combining the identifier and timestamp along with some randomizer via concatenation or other operation, and then applying a hash function (such as Secure Hash Algorithm), a backdoor key can be generated that is usable only on that specific host for a limited period of time. The algorithm may be a 1-way function such as the Secure Hash Algorithm mentioned above, or other function that is easy to compute but whose inverse is very difficult to compute. The randomizer may be a randomly generated seed that is coded into the application 102 and is also used by the manufacturer to generate the backdoor key, or it could depend on some environmental information such as timestamp, time zone, etc. as long as the utility that generates the key and the application 102 determine it the same way.

When this key is entered by a user, step 156, the console server 100 compares the key with a value that the server 100 computes, by using the same algorithm (hash of its IP address and the last second of the current month and the randomizer), steps 158 and 160. The computation may include encryption, in which case the value is compared directly to the key. Otherwise, the server 100 may decrypt the key before performing the comparison. If the two values match, the key is valid, step 162. The application 102 may reset the administrator password by issuing a command to database system 104 to reset the administrator password in database 106 to a default value, step 164, or treat the key entry as a successful administrator login. The user may then login using the default administrator password, if not already logged in, and change the administrator password from the default value to a secure value, step 166.

A 2-way function such as DES (Digital Encryption Standard) may be used. In this case, the backdoor key would be encrypted and sent to the customer, who would enter it into the console application 102. Application 102 decrypts this to obtain the backdoor key. The backdoor key may comprise a hash of the server 100 IP address and the last second of the current month, to uniquely identify the customer's server 100 and limit the life of the key.

In an embodiment, the computer and application that receive the backdoor key and validate it need not be console server 100 and application 102, but a separate computer and application that have access to database system 104 to instruct it to reset the administrator password.

The backdoor key approach mitigates the need for the customer to send its database back to the manufacturer to reset the administrator password if the administrator password is lost, while at the same time preserving the security of applications 102 installed by other customers. The interaction with the manufacturer's technical support may be minimal and delay significantly reduced. The use of a unique identifier in computing the key makes the key specific to a customer's system, and prevents its use on another system, such as a system belonging to another customer. The use of a timestamp in computing the key limits its lifetime, reducing the period of vulnerability if the key is intercepted. The application 102 may be configured so that a key may be used only once, and require the next key to be generated with a timestamp adjusted by a certain amount (such as seven seconds later than the timestamp of the first key).

Access to administrator functions in the application 102 may be provided by using a flag, such as an environment variable, that is checked by the application 102 at startup time. The flag must be modifiable only by an administrator or other users to whom the customer desires to give administrator-level access to the application 102. If the application 102 detects that the flag has been set to some pre-determined value (and thus made active), the application 102 may allow administrator-level access, allowing the current user to modify the administrator password stored by the database system 104, or simply reset the administrator password to its default value. After the administrator password has been reset, the user may then unset the flag to return to normal functioning. Alternatively, the application 102 may act on a flag that has been unset.

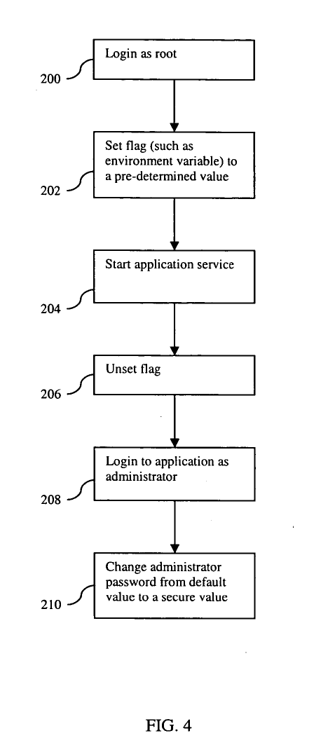

Referring to FIG. 4, an environment variable may be used as the flag, and the application may be configured to require administrator privileges to invoke it. The user logs in as root, step 200. The environment variable may be set by using a setenv or similar command, step 202. The user then starts the application, step 204, and the application resets the administrator password. The user unsets the environment variable, step 206, and logs in to the application as administrator, step 208. The user may then change the administrator password from the default value to a secure value, step 210. Although various steps have been described herein, they do not necessarily have to be performed in the sequence shown. For example, the environment variable does not have to be checked immediately upon startup, and some other functions may be performed first. Also, the environment variable does not have to be unset before the user can login as administrator or change the administrator password. However, the environment variable should be unset before the application 102 is restarted, because if this flag is still set, the application 102 will again reset the administrator password.

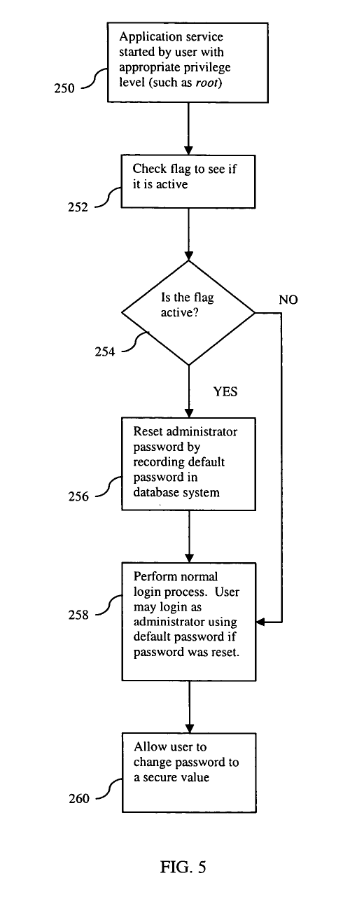

The operation of the application 102 is shown in FIG. 5. When the application process is started, step 250, the environment variable is checked, step 252. In step 254, if the flag is active (e.g., set to a pre-determined value such as TRUE or a non-null value), the application 102 instructs the database system 104 to change the administrator password to the default password, step 256. The application 102 now performs a normal login process, step 258, allowing the user to login as administrator using the default password. In step 260, the application 102 allows the user to change the password to a secure value, and records the changed password by sending a command to the database system 104 to store the password in database 106. If the application 102 is configured such that it requires root access to start, this ensures that the person being given administrator-level access to application 102 has sufficient security access.

In the case of the NetWorker Management Console application 102, the environment variable is called GST₁₃ RESET_PW. If this variable is set to any value on the console server 100 and the GST service is (re)started, such as by invoking the program from the shell, the reset function will be invoked. When this happens, the console application 102 sends an SQL command to the database system 104 instructing it to change the administrator password to its default value, such as “administrator”. Database system 104 records the changed password in database 106. Once the reset function has been invoked, the user then unsets the GST_RESET_PW flag on the server 100. As long as the flag remains set, the administrator's password will continue to be reset to its default value every time the GST service is restarted. The administrator will be able to login to the application 102 and change the administrator password to a secure value. This changed password is recorded in database 106 by database system 104.

In an embodiment, the computer and application that check the flag need not be console server 100 and application 102, but a separate computer and application that have access to database system 104 to instruct it to reset the administrator password.

It is advantageous to use the environment variable as the flag to reset the password, because it offers a secure method to invoke the administrator password reset function, without the need to login to the application 102. No interaction with the manufacturer's technical support is required for this approach.

Although the methods and systems herein have been described with respect to a Unix system, they are also applicable to other systems, including but not limited to Windows 2000.

The foregoing disclosure and embodiments demonstrate the utility of the present invention in providing users with the ability to securely and independently reset passwords, although it will be apparent that the present invention will be beneficial for many other uses.

For the sake of clarity, the processes and methods herein have been illustrated with a specific flow, but it should be understood that other sequences may be possible and that some may be performed in parallel, without departing from the spirit of the invention. Additionally, steps may be subdivided or combined. For example, after a command has been issued to reset the password, the flag may be unset before the command completes. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The present embodiments are to be considered as illustrative and not restrictive, and the invention is not to be limited to the details given herein. It is therefore intended that the disclosure and following claims be interpreted as covering all such alterations and modifications as fall within the true spirit and scope of the invention.

1. A method of resetting a key for accessing a computer program, comprising:
setting a flag to indicate that the key is to be reset;
starting a process associated with the program;
determining, when the process has been started, whether the flag is set; and
resetting the key to a default value based on the flag.

2. The method as recited in claim 1, wherein starting the process comprises requiring sufficient privileges to start the process.

3. The method as recited in claim 2, further comprising logging in with sufficient privileges to start the process.

4. The method as recited in claim 2, wherein the flag is an environment variable.

5. The method as recited in claim 4, wherein resetting the key to a default value includes instructing a database system to reset the key.

6. The method as recited in claim 4, further comprising unsetting the flag.

7. The method as recited in claim 6, further comprising starting the process again.

8. The method as recited in claim 6, further comprising changing the key from the default value to a secure value.

9. A system for resetting a key for accessing a computer program, comprising a computer configured to:
determine whether a flag is set, when a process associated with the computer program is started; and
reset the key to a default value, based on the flag.

10. The system as recited in claim 9, further configured to require administrator privileges to start the process.

11. The system as recited in claim 10, wherein the flag is an environment variable.

12. The system as recited in claim 11, further comprising a database system configured to store the key, and wherein the system is configured to reset the key by instructing the database system to reset the key.

13. The system as recited in claim 9, wherein the key is associated with an administrator account for accessing the computer program.

14. The system as recited in claim 9, wherein the computer program executes on the computer.

15. The system as recited in claim 9, wherein the computer program executes on a second computer.

16. A computer program product for resetting a key for accessing a computer program, comprising a computer usable medium having machine readable code embodied therein for:
determining whether a flag is set, when a process associated with the computer program is started; and
resetting the key to a default value, based on the flag.

17. The computer program product as recited in claim 16, further comprising a database system configured to store the key, and wherein resetting the key includes instructing the database system to reset the key.

18. The computer program product as recited in claim 16, wherein the key is associated with an administrator account for accessing the computer program.

19. The computer program product as recited in claim 16, further comprising code for requiring sufficient privileges to start the process.

20. The computer program product as recited in claim 16, further comprising code for changing the key from the default value to a secure value.
